(19) United States
(12) Patent Application Publication
(10) Pub. No.: US 2011/0176516 A1
(43) Pub. Date: Jul. 21, 2011

(54) Systems and Methods for Bandwidth Allocation

(75) Inventors: Udit Thakore, Fairfax, VA (US); Siddhartha Chenumolu, Ashburn, VA (US); Rajesh Mundiath Gangadhar, Ashburn, VA (US)

(73) Assignee: Clear Wireless LLC, Kirkland, WA (US)

(21) Appl. No.: 12/691,018

(22) Filed: Jan. 21, 2010

(51) Int. Cl. H04B 7/216; H04W 76/00; H04B 7/208

(52) U.S. Cl. 370/335; 370/329; 370/344

(57) ABSTRACT

Systems and methods for allocating uplink bandwidth are provided. A base station transmits an identification of a plurality of codes and an associated service flow type for each of the plurality of codes to a wireless station. The base station receives a bandwidth request message from the wireless station. The bandwidth request message is one of the plurality of codes. The base station transmits a bandwidth allocation message allocating bandwidth based on a service flow type associated with the received code.

### BACKGROUND OF THE INVENTION

In most communication systems bandwidth is a limited resource that is allocated for communications between endpoints. Bandwidth in wireless communication systems is typically limited by the amount of licensed frequencies and interference in a particular geographic area. In structured wireless communication systems the network typically controls the allocation of bandwidth for transmissions from the base station to the wireless stations (i.e., downlink transmissions) and transmissions from the wireless stations to the base stations (i.e., uplink transmissions). The particular manner in which bandwidth is allocated for uplink and downlink transmissions is typically defined by international standards bodies, and network operators typically do not deviate from the allocation techniques defines by international standards bodies.

### SUMMARY OF THE INVENTION

Exemplary embodiments of the present invention provide systems and methods for bandwidth allocation. As will be described in more detail below, exemplary embodiments of the present invention associate one or more ranging codes to each of a plurality of service flow types, and a wireless station can use one of the plurality of received codes to request bandwidth.

An exemplary method involves a base station transmitting to a wireless station an identification of a plurality of codes and an associated service flow type for each of the plurality of codes. The base station receives a bandwidth request message from the wireless station, the bandwidth request message being one of the plurality of codes. The base station then transmits a bandwidth allocation message to the wireless station in order to allocate bandwidth based on a service flow type associated with the received code.

The allocated bandwidth can be a minimum reserved traffic rate (MRTR) for the service flow type associated with the received code. The wireless station uses the allocated bandwidth to send a data burst. If additional bandwidth is required, the data burst can include a request for additional bandwidth. The request for additional bandwidth can be included in a bandwidth request header portion of the data burst.

More than one of the plurality of codes can be associated with each of the plurality of service flow types. The plurality of service flow types can include real-time polling services (rtPS), extended real-time polling services (ertPS) and non-real-time polling services (nrtPS).

The plurality of codes can be orthogonal codes, such as code division multiple access (CDMA) codes. The allocation and data transmissions between the base station and wireless station can be performed using orthogonal frequency division multiple access (OFDMA).

The identification of the plurality of codes and the identification of the associated service flow types can be transmitted in an uplink channel descriptor (UCD).

Other objects, advantages and novel features of the present invention will become apparent from the following detailed description of the invention when considered in conjunction with the accompanying drawings.

### BRIEF DESCRIPTION OF THE DRAWING FIGURES

FIG. 1 is a block diagram of a conventional communication frame.

FIG. 2 is a call flow diagram of a conventional uplink bandwidth allocation procedure.

FIG. 3 is a call flow diagram of an exemplary uplink bandwidth allocation procedure in accordance with the present invention.

### DETAILED DESCRIPTION OF THE PREFERRED EMBODIMENTS

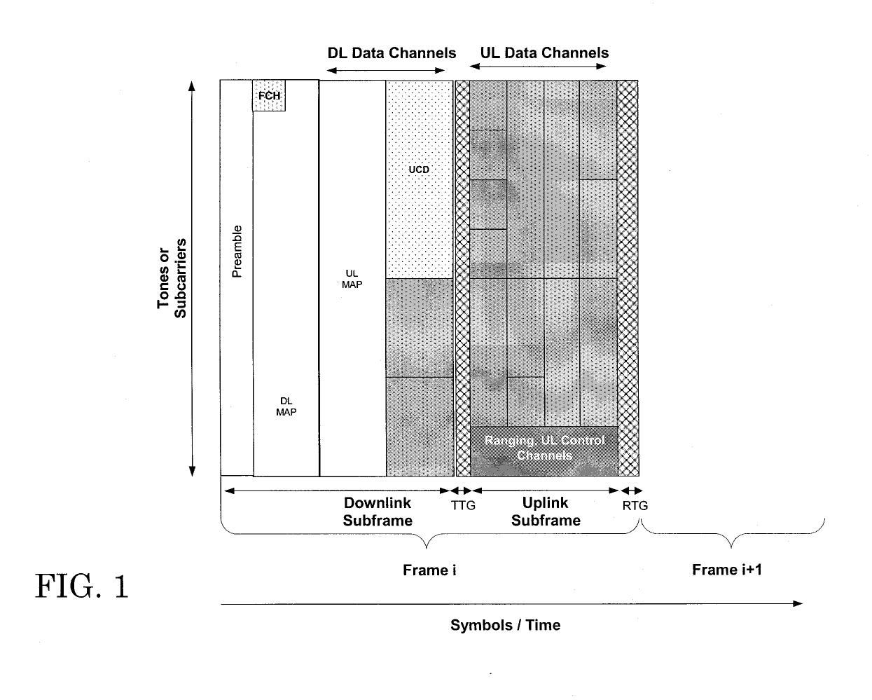

FIG. 1 is a block diagram of a conventional communication frame. FIG. 1 illustrates an exemplary orthogonal frequency division multiple access (OFDMA) frame with Time Division Duplexing (TDD) as the main physical layer (PHY) mode used for mobility within IEEE 802.16e. The horizontal axis represents time, while the vertical axis represents frequency tones or subcarriers. An OFDMA frame in a TDD system is divided into downlink and uplink subframes. Between the downlink and uplink subframes of a particular frame is a transmit transmission gap (TTG), which provides time for a base station to transition from a transmission mode to a receive mode and mobile stations to transition from a receive mode to a transmission mode. A receive transmission gap (RTG) is provided between an uplink subframe of one frame and the downlink subframe of a subsequent frame. The RTG provides base stations time to transition from a receive mode to a transmission mode and mobile stations to transition from a transmission mode to a receive mode.

In the frame of FIG. 1, the downlink subframe includes a preamble, frame control header (FCH), downlink MAP (DL-MAP), uplink MAP (UL-MAP) and downlink data channels. The preamble is used by mobile stations for cell acquisition and frame synchronization. The FCH is a broadcast channel located right after preamble, and includes information indicating the size of DL-MAP, repetition coding and forward error correction (FEC) coding used in DL-MAP, and other information related to the current frame. The DL-MAP, which follows immediately after FCH, includes a number of information elements (IEs), which define the usage of the downlink data channels and includes information such as frame synchronization, paging messages, downlink channel allocations and configuration change counts. The UL-MAP includes a number of information elements (IEs), which define the usage of the uplink data channels, and includes information such as uplink channel allocations, and uplink configuration change counts. At fixed intervals of time the mapping (i.e., location) of an Uplink Channel Descriptor (UCD) is sent in the UL-MAP. The interval is operator configurable, and can be, for example, 1 second. The downlink data channels are used to transport data from a base station to other wireless stations, e.g., fixed or mobile stations. The uplink subframe includes the uplink data channels, as well as ranging and uplink control channels.

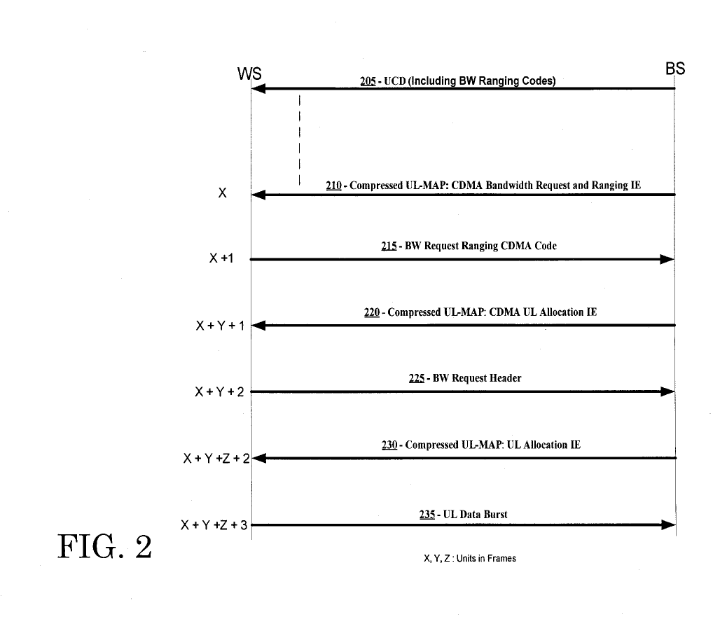

FIG. 2 is a call flow diagram of a conventional procedure for a base station to allocate uplink bandwidth to a wireless station. The wireless station can be any type of wireless station, and can be fixed or mobile. The base station includes an identification of a number of code division multiple access (CDMA) ranging codes in the UCD message (step 205).

The base station periodically identifies a location within the frame for wireless stations to use for bandwidth request and paging information in a compressed UL-MAP (step 210). This is the starting point for the uplink bandwidth request process. A wireless station randomly selects one of the CDMA ranging codes and transmits the selected code to the base station (step 215). This is a contention based process and the transmission from the wireless station to the base station can collide with other bandwidth requests due to the selection of the same CDMA code by other wireless stations. It will be recognized that only the code itself is sent, but there is no identification of the wireless station that sent the code.

Approximately 4 frames later the base station transmits a CDMA UL allocation information element (IE) in the compressed UL-MAP requesting that the wireless station identify the amount of bandwidth required (step 220). Because the base station is not aware of the identification of the wireless station that sent the ranging code, this transmission is a broadcast transmission. The wireless station responds with the amount of requested bandwidth in a bandwidth request header message in the uplink data channel (step 225). The base station then responds with an uplink channel allocation information element (IE) in the compressed UL-MAP approximately 3 frames later (step 230).

There is an inherent delay (Z) between the receipt of the bandwidth request header and the transmission of the UL Allocation IE, the delay being dependent upon the particular base station scheduler design and the system loading. The amount of bandwidth that is actually allocated depends not only on the amount of bandwidth requested but also on the amount of physical resources available (i.e., the number of subcarriers), interference and allocated power. The mobile station can then begin to use the allocated bandwidth by transmitting an uplink data burst in one of the uplink data channels (step 235). The entire bandwidth allocation process, starting from the transmission of the information elements (IEs) for the CDMA bandwidth request and ranging until the actual allocation is at least 8 frames (i.e., 40 ms), not accounting for any delays associated with the base station scheduler (i.e., delay Z).

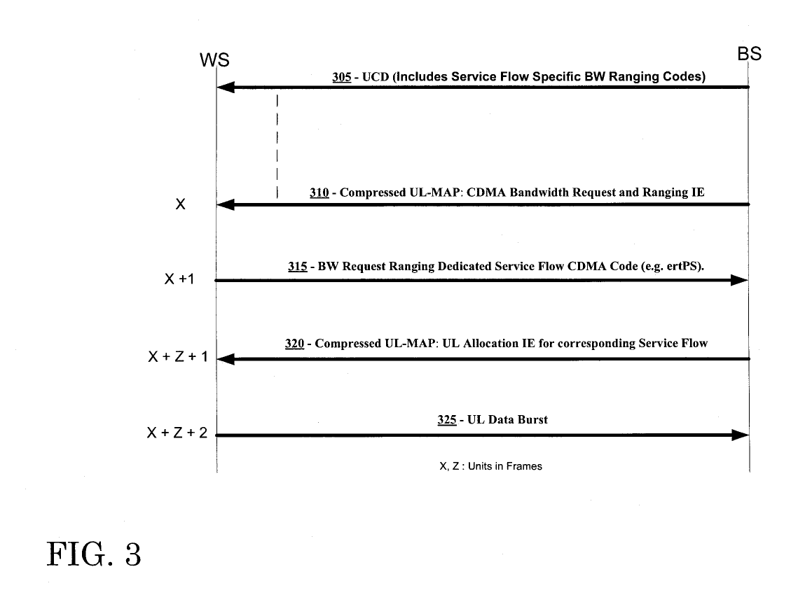

FIG. 3 is a call flow diagram of an exemplary uplink bandwidth allocation procedure in accordance with the present invention. Again, the wireless station can be any type of wireless station, and can be fixed or mobile. As will be described in more detail below, the call flow of the present invention can allocate uplink bandwidth quicker than the conventional procedure described above. This is achieved, in part, by using service flow specific bandwidth ranging codes and assigning a minimum reserved traffic rate (MRTR) for the particular service flow. In particular, the base station assigns one or more bandwidth ranging codes to each of a plurality of service flows, such as real-time polling services (rtPS), extended real-time polling services (ertPS) and non-real-time polling services (nrtPS). Accordingly, the base station transmits an identification of the bandwidth ranging codes and an identification of an associated service flow type for each bandwidth ranging code in the Uplink Channel Descriptor (UCD) (step 305).

The base station periodically identifies a location within a frame for transmission of bandwidth requests and ranging information using the compressed UL-MAP (step 310). Whenever a wireless station desires bandwidth the station requests bandwidth by transmitting one of the CDMA codes for the service flow desired by the wireless station (step 315). The wireless station transmits the code itself, but not an identification of the wireless station. The base station responds by providing the uplink allocation information element (IE) for the corresponding service flow in the compressed UL-MAP (step 320). Because the base station is not aware of the identity of the wireless station that sent the code, this message is a broadcast message. The amount of bandwidth that is allocated is a minimum reserved traffic rate (MRTR) for the particular service flow. The wireless station can then begin to use the allocated bandwidth by transmitting an uplink data burst (step 325). If the wireless station desires bandwidth beyond the minimum reserved traffic rate MRTR for the particular service flow, the wireless station can request additional bandwidth using a bandwidth request header in the initial uplink data burst.

As can be seen by comparing the call flows of FIGS. 2 and 3, the present invention reduces the time for bandwidth allocation by approximately 4 frames (i.e., 20 ms). This is achieved by eliminating the delay Y, between the transmission of the bandwidth request ranging CDMA code from the wireless station and the CDMA uplink allocation information element (IE) transmitted from the base station. The call flow of the present invention also eliminates the separately transmitted bandwidth request header (step 225) by allocating a minimum reserved traffic rate MRTR for the particular service flow, thus resulting in an elimination of Y+1 frames of delay compared to the conventional bandwidth allocation techniques.

The bandwidth allocation procedure of the present invention introduces the concept of service flow specific bandwidth ranging codes, which is not currently specified in the 802.16 WiMAX standard. Thus, the convention Uplink Channel Descriptor (UCD) Type/Length/Value (TLV) can be used to identify assignment of codes to specific service flow types. The UCD TLV is specified in section 11.3 in 802.16, Rev2/D1 Part 16: Air Interface for Broadband Wireless Access Systems, the entire disclosure of which is herein expressly incorporated by reference. Additionally, the Uplink Allocation Start information element (IE) should include proper syntax to specify the dedicated ranging code, ranging symbol and ranging subchannel. These pieces of information are currently carried in the CDMA Allocation IE, and not the Uplink Allocation Start IE.

Although the present invention has been described in connection with one base station and one wireless station, the present invention can be used by more than one wireless station supported by any particular base station and by any number of base stations in a network. Additionally, although the present invention has been described as using particular messages, the present invention can be employed with different messages. Finally, the specific service flows described above are merely exemplary and the present invention can employ any type of service flows.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method comprising the acts of:
transmitting, by a base station to a wireless station, an identification of a plurality of codes and an associated service flow type for each of the plurality of codes;
receiving, by the base station from the wireless station, a bandwidth request message, the bandwidth request message being one of the plurality of codes;
transmitting, by the base station to the wireless station, a bandwidth allocation message allocating bandwidth based on a service flow type associated with the received code.

2. The method of claim 1, wherein the allocated bandwidth is a minimum reserved traffic rate (MRTR) for the service flow type associated with the received code.

3. The method of claim 2, further comprising:
receiving, by the base station from the wireless station, a data burst over the allocated bandwidth, wherein the data burst includes a request for additional bandwidth.

4. The method of claim 3, wherein the request for additional bandwidth is included in a bandwidth request header portion of the data burst.

5. The method of claim 1, wherein more than one of the plurality of codes is associated with each of the plurality of service flow types.

6. The method of claim 1, wherein the plurality of service flow types include real-time polling services (rtPS), extended real-time polling services (ertPS) and non-real-time polling services (nrtPS).

7. The method of claim 1, wherein the plurality of codes are orthogonal codes.

8. The method of claim 7, wherein the orthogonal codes are code division multiple access (CDMA) codes.

9. The method of claim 1, wherein transmissions between the base station and wireless station are performed using orthogonal frequency division multiple access (OFDMA).

10. The method of claim 1, wherein the identification of the plurality of codes that are associated with the service flow types is transmitted in an uplink channel descriptor (UCD).

11. A method comprising the acts of:
receiving, by a wireless station from a base station, an identification of a plurality of codes and an associated service flow type for each of the plurality of codes;
determining, by the wireless station, that data associated with a particular one of the plurality of service flow types is to be transmitted to the base station;
transmitting, by the wireless station to the base station, a bandwidth request message, the bandwidth request message being a code associated with the particular one of the plurality of service flow types; and
receiving, by the wireless station from the base station, a bandwidth allocation.

12. The method of claim 11, wherein the allocated bandwidth is a minimum reserved traffic rate (MRTR) for the service flow type associated with the transmitted code.

13. The method of claim 11, further comprising:
transmitting, by the wireless station to the base station, a data burst over the allocated bandwidth, wherein the data burst includes a request for additional bandwidth.

14. The method of claim 13, wherein the request for additional bandwidth is included in a bandwidth request header portion of the data burst.

15. The method of claim 11, wherein more than one of the plurality of codes is associated with each of the plurality of service flow types.

16. The method of claim 11, wherein the plurality of service flow types include real-time polling services (rtPS), extended real-time polling services (ertPS) and non-real-time polling services (nrtPS).

17. The method of claim 11, wherein the plurality of codes are orthogonal codes.

18. The method of claim 17, wherein the orthogonal codes are code division multiple access (CDMA) codes.

19. The method of claim 11, wherein transmissions between the base station and wireless station are performed using orthogonal frequency division multiple access (OFDMA).

20. The method of claim 11, wherein the identification of the plurality of codes that are associated with the service flow types is received in an Uplink Channel Descriptor (UCD).
